(19) United States
(12) Patent Application Publication
(10) Pub. No.: US 2004/0095054 A1
(43) Pub. Date: May 20, 2004

(54) Color cathode ray tube

(76) Inventor: Jong-Eon Choi, Kyongsangbukdo (KR)

Correspondence Address: BIRCH STEWART KOLASCH & BIRCH, PO BOX 747, FALLS CHURCH, VA, 22040-0747, US

(21) Appl. No.: 10/471,799

(22) PCT Filed: Nov. 1, 2001
(86) PCT No.: PCT/KR01/01847

(30) Foreign Application Priority Data
Mar. 16, 2001 (KR) 2001-13772

(51) Int. Cl. H01J 29/70

(52) U.S. Cl. 313/421

(57) ABSTRACT

A color cathode ray tube is disclosed, in which a purity correction means is installed in an outer side between an effective region and an effective screen, thereby decreasing distortion of the screen without deteriorating characteristics of a deflection yoke, and minimizing change of a misconvergence to improve color purity of the screen and productivity. To this end, the color cathode ray tube includes a panel 10 constituting a screen; a funnel 20 attached at the rear of the panel, having a bulb shape; a shadow mask 30 installed to be separated from the panel for choosing colors; and a purity correction means 60 installed to be close to the shadow mask. More preferably, the purity correction means 60 is attached in a range from a margin (S) of an effective screen of a panel to an effective end of the shadow mask 30 in an entire surface of the panel in which distortion of the screen is generated.

### TECHNICAL FIELD

The present invention relates to a color cathode ray tube, and more particularly, to structure of means and method for correcting a purity, in which picture distortion and misconvergence are made to be minimum in correcting a purity shift (=landing) occurred in a periphery of a screen of a color cathode ray tube (CRT).

### BACKGROUND ART

Referring to FIG. 1, in general, the color CRT is provided with a panel 1 having a fluorescent screen formed on an inside surface thereof, a funnel 2 of a bulb form fitted to rear of the panel 1, a shadow mask 3 fitted to the panel 1 with a space from the panel 1 for selecting a color, an electron gun 4 sealed in a neck part of the funnel for emitting electron beams 41, and a deflection yoke 5 fitted to an outside circumferential surface of the funnel for deflecting the electron beams from the electron gun.

There is an anti-implosion glass 11 attached to a front surface of the panel 1 for prevention of implosion that is an inward explosion of the panel even if a small impact is given to the panel, and there is an anti-implosion strap 12 around outside circumferences of the panel 1 and the funnel 2 close to the panel 1.

There is a convergence purity magnet (CPM) 6 of in general 2, 4, or 6 polar annular magnet fixed by a ring to the deflection yoke for eliminating imbalance of a color.

Upon putting the foregoing color CRT into operation, the electron beams 41 are emitted from the electron gun 4 of an in-line type having cathodes arranged on a line for emitting red, green, and blue color electron beams respectively toward the panel 1 by a potential difference between the cathodes and an anode.

Then, the electron beams 41 are accelerated and focused within the electron gun so as to be focused at a point in front of a slot in the shadow mask 3, cross one another as the electron beams 41 pass the slot, to select one of the colors, and reaches to the fluorescent screen 13.

Then, the electron beams 41 hit fluorescent material of an opposite fluorescent screen 13, to emit a light, thereby forming a picture. The electron beams 41 are deflected by the deflection yoke 5, so as to scan an entire region of the fluorescent screen 13.

However, there has been a problem of a color purity deterioration caused by inaccurate hitting of the electron beams at the screen coming from various causes, such as production process, accuracy of components, and the like. As one of method for solving the problem, a purity correcting method is employed.

In general, the purity is corrected by fitting a sensor purity magnet 6 between the deflection yoke 5 and the funnel 2, for shifting paths of the electron beams.

Therefore, referring to FIG. 2, the electron beams 41 are involved in path correction to electron beams 41a represented with solid line as the electron beams 41 pass a region the convergence purity magnet 6 fitted to an outside circumference of the funnel 2, before the electron beams land on the fluorescent screen 13.

However, since the related art convergence purity magnet 6 is fitted in rear of the shadow mask 3, the related art convergence purity magnet 6 can not but correct the paths of the electron beams before the electron beams 41 reach to the shadow mask 3.

According to this, as a ratio of a distance between the shadow mask 3 and a deflection center D.C to a distance between the fluorescent screen 13 to the shadow mask 3 is approx. 30 to 1, even if the paths of the electron beams are corrected very slightly by using the convergence purity magnet 6, the correction of the purity landed on the fluorescent screen 13, i.e., mislanding, is significant.

That is, even if the paths of the electron beams are corrected by using the convergence purity magnet 6 for correcting a very small amount of mislanding of the electron beams, an amount L1 of distortion on the screen is significant.

In comparison to this, since a required amount L2 of the purity correction is very small, the correction of distortion amount on the screen is almost not made, resulting to deteriorate the color purity.

Referring to FIG. 3, if the electron gun 4 is of the in-line type, there are differences of distances of the electron beams 41 from the electron gun having the cathodes arranged on a line to the convergence purity magnet 6.

That is, since a distance ‘b’ from the convergence purity magnet 6 to the blue electron beam is shorter than a distance ‘a’ from the convergence purity magnet 6 to the red electron beam, amounts of travel of the electron beams differ in an order of Ra>Ga>Ba turned up at a time when the electron beams 41a corrected by the convergence purity magnet 6 land on a surface of the fluorescent screen through the shadow mask.

Consequently, a picture of exact colors can not be provided because color signals are not same due to the misconvergence in which positions of the three color electron beams are incorrect.

According to this, the re-adjustment of the deflection yoke or an additional correction required for correcting distortion of a picture and misconvergence even after correction of the purity by using a convergence in the related art drops a productivity of the color CRT, and a performance of the deflection yoke, and causes defects of the deflection yokes.

### DISCLOSURE OF INVENTION

An object of the present invention related to a color CRT, and more particularly, for improvement of a color purity of a picture and a productivity by fitting purity correcting means to an outer side between an effective area of the shadow mask and the effective screen area for reducing the distortion of a picture and minimizing change of misconvergence while performance of the deflection yoke is not deteriorated.

To achieve the object of the present invention, there is provided a color cathode ray tube (CRT) having a panel forming a screen, a funnel of a bulb form fitted to rear of the panel, and a shadow mask fitted to the panel spaced away therefrom, the color CRT including purity correcting means is fitted to a part in front of, or in side of the shadow mask near thereto.

More preferably, the purity correcting means is fitted to a front surface of the panel within a range starting from an edge ‘S’ of an effective screen of the panel to an effective end ‘M’ of the shadow mask. The purity correcting means is a magnetic material having approx. 20-80 Gauss in a high resolution color CRT, and 30-150 Gauss in a low resolution color CRT.

The purity correcting means is fitted to an outside circumferential surface of the panel located in front of the shadow mask, such that a length direction axis or a direction of magnetic field forms a range of angle approx. within ±30 degrees to a tube axis of the electron beams emitted toward a panel. The purity correcting means is preferably fitted to an inside of a cabinet covering the color CRT within a range starting from an edge of an effective screen of the panel to an effective end of the shadow mask.

The purity correcting means is fitted to a front surface of the panel within a space between an anti-implosion glass fitted to the front surface of the panel and an anti-implosion strap around the panel in a case the purity correcting means is fitted to a flat color CRT. The purity correcting means is fitted to the front surface of the panel, with an N pole thereof directed upward or downward in parallel to a vertical axis of the panel when the screen is of a stripe type.

The purity correcting means is fitted within a range that satisfying an inequality 1.0<L2/L1<2.0, where L1 represents a purity (=landing) correction amount by the purity correcting means and L2 represents a picture distortion amount by the purity correcting means, which man be represent in view of positions such that the purity correcting means is fitted within a range that satisfying an inequality 1.0<P/Q<2.0, where ‘M’ represents an effective shadow mask area with reference to a tube axis direction, ‘Q’ represents a distance from the effective end of the shadow mask to the end of the effective screen of the panel, and ‘P’ represents a distance from the end of the effective screen to the purity correcting means.

### BRIEF DESCRIPTION OF DRAWINGS

FIG. 1 illustrates an upper section with a key part cut away view of a related art color CRT;

FIG. 2 illustrates a section of a color CRT showing correction of a path of an electron beam by using a related art convergence purity magnet, schematically;

FIG. 3 illustrates a section of a color CRT showing correction differences of electron beams caused by distance differences between electron beams and a related art convergence purity magnet, schematically;

FIG. 4 illustrates a section of a color CRT schematically showing a principle in which an electron beam path is corrected by purity correcting means of the present invention;

FIG. 5 illustrates a section of purity correcting means of the present invention;

FIG. 6 illustrates a section showing fitting purity correcting means in accordance with a first preferred embodiment of the present invention;

FIG. 7 illustrates a section showing fitting purity correcting means in accordance with a second preferred embodiment of the present invention;

FIG. 8 illustrates a section showing a fitting position of purity correcting means in accordance with a third preferred embodiment of the present invention;

FIG. 9 illustrates a frontal section showing a state in which purity correcting means is fitted to a front surface of a color CRT in accordance with a preferred embodiment of the present invention;

FIG. 10 illustrates a table showing amounts of mislanding correction varied with fitting positions; and

FIG. 11 illustrates a section showing a preferable fitting position of the purity correcting means m accordance with a preferred embodiment of the present invention.

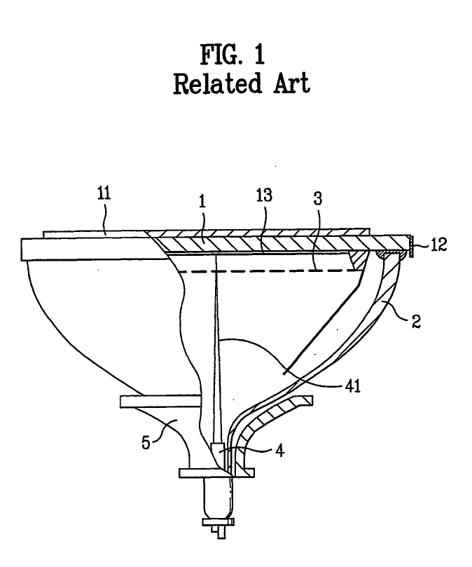

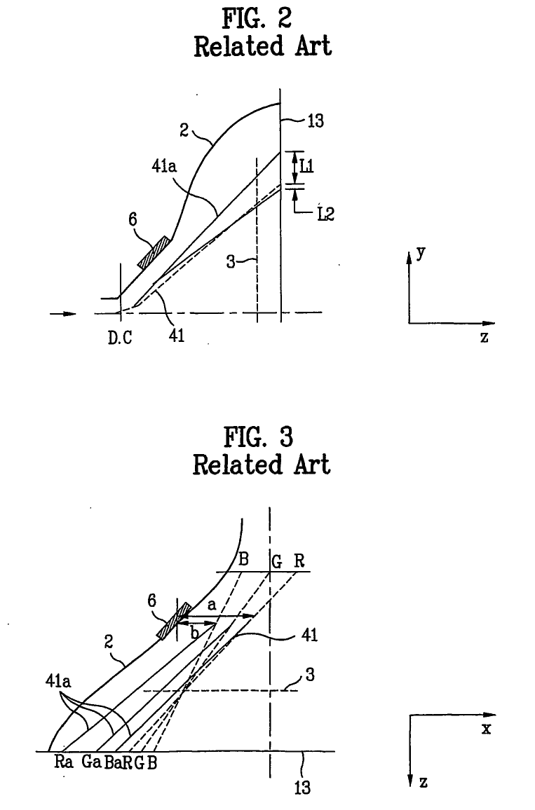

### BEST MODE FOR CARRYING OUT THE INVENTION

Preferred embodiments of the present invention that can achieve the objects of the present invention will be explained, with reference to the attached drawings. In explaining the present invention, parts the same with the related art will be given the same names and reference symbols.

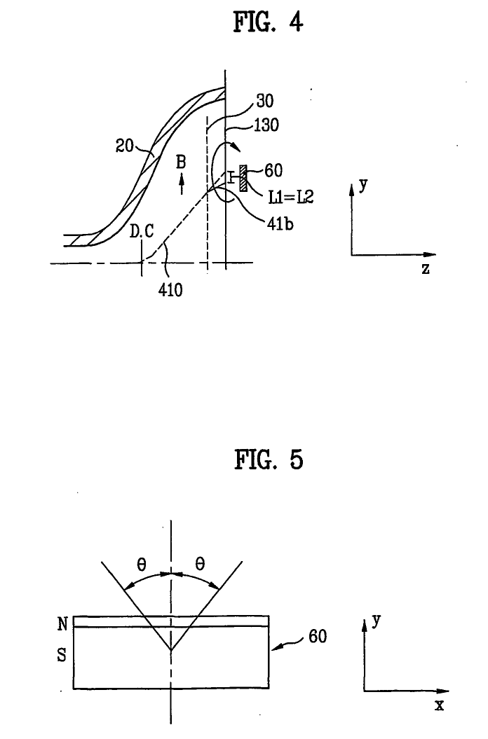

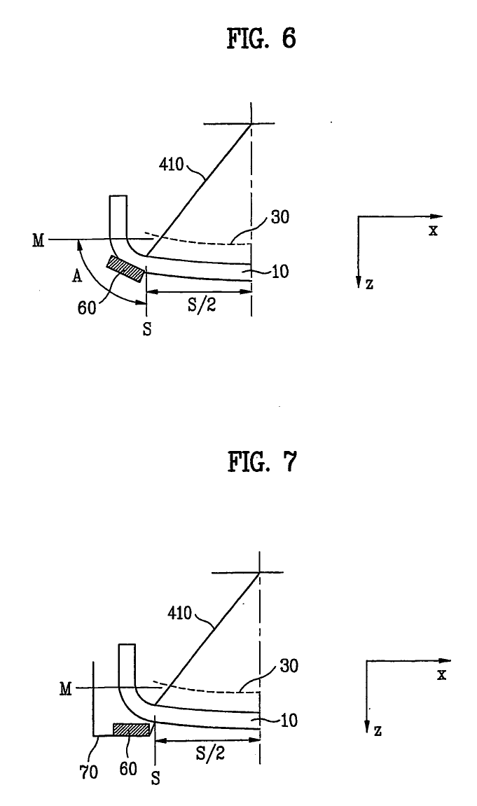

FIGS. 4 and 5 illustrate drawings each for explaining a purity correcting principle by using purity correcting means of the present invention, and FIGS. 6 to 8 illustrate sections each showing fitting position of purity correcting means in accordance with a preferred embodiment of the present invention.

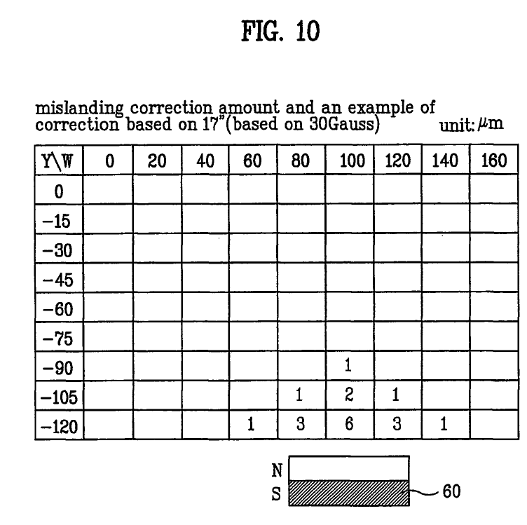

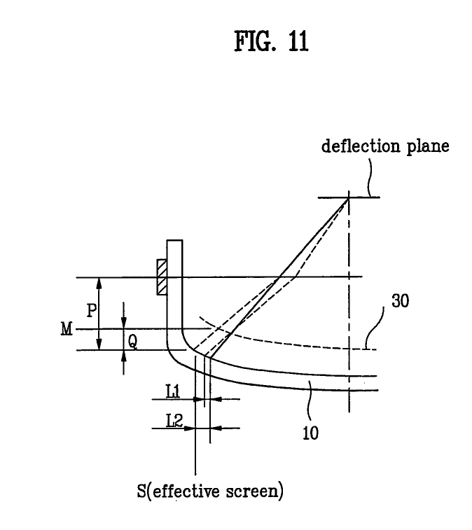

FIG. 9 illustrates a frontal section showing a state in which purity correcting means is fitted to a front surface of a color CRT in accordance with a preferred embodiment of the present invention, FIG. 10 illustrates a table showing amounts of mislanding correction varied with fitting positions, and FIG. 11 illustrates a section showing a preferable fitting position of the purity correcting means in accordance with a preferred embodiment of the present invention.

The purity correcting means and the purity correcting principle of the present invention will be explained.

Since a picture distortion amount and a purity correcting amount on a fluorescent screen are almost same when the purity correcting means of a magnetic flux density is fitted in front of the shadow mask, the color purity can be improved.

When the purity correcting means is fitted to a part around a side surface, or rear, of the shadow mask, the picture distortion amount is turned up greater than the purity correcting amount, which becomes more significant when the fitting position of the purity correcting means becomes the farther away from the fluorescent screen to the electron gun.

Consequently, because the picture distortion amount becomes greater than the purity correcting amount, failing a proper correction of the distortion by the purity correcting means, the color purity becomes poorer.

Referring to FIG. 4, by utilizing this phenomenon, the purity correcting means 60 is fitted to part in front of the shadow mask 30, particularly, to a front surface of the panel 10, so that the electron beam 410 shown in a dotted line deflected at a deflection center D.C by the deflection yoke 50 within the funnel 20 and directed to a periphery of the fluorescent screen 130 is involved in path correction according to the Fleming's left hand law.

That is, as a magnetic field ‘B’ is formed by the purity correcting means 60 perpendicular to the electron beam 41 traveling in a direction opposite to a direction of a current ‘i’, the three color electron beams 410 crossing one another as the three color electron beams 410 pass the shadow mask 30 are involved in change of paths of the electron beams 410b in a direction represented with a vector F after the electron beams 410b pass the shadow mask 30.

Therefore, even if traveling distances of the electron beams are short, the purity correcting amount L2 almost identical to the picture distortion amount L1 that can minimize a distortion of the picture can be produced.

Referring to FIG. 5, such purity correcting means 60, a bipolar magnetic material with an N pole and an S pole, has a length, a strength of a magnetic field, and the like varied with a required correcting amount.

In the meantime, if the purity correcting means 60 is fitted such that an angle between a length direction axis (y-axis) of the purity correcting means 60 and a tube axis (z-axis) of the electron beams is equal to, or greater than +30°, an effect of path shift of the electron beams by the Fleming's left hand law is reduced, to expect the purity correcting effect, hardly.

In this instance, position and method for fitting the purity correcting means 60 differ depending on a structure of the fluorescent screen 130 of the color CRT at which the picture distortion occurs.

That is, if the fluorescent screen 130 is of a stripe type in which the red, green, and blue fluorescent materials are arranged like lateral lines, no path correction of the electron beams in a y-axis direction is required.

Accordingly, in order to resolve distortion amount correction of the electron beams in the x-axis direction perpendicular to the stripe only, the purity correcting means 60 is fitted in the vicinity of the shadow mask, particularly, around the screen, with the N pole directed upward or downward.

Consequently, since the N pole of the purity correcting means 60 is directed upward or downward of a y-axis of the panel, with the magnetic field formed perpendicular to the current, the electron beams are shifted in left or right direction in the x-axis direction, to correct the x-direction distortion.

In this instance, the purity correcting means 60 is fitted to a part in the vicinity of the shadow mask 30, or to a front surface of the panel 10, at which distortion correction is required to be within an angle between a tube axis direction of the electron beam 410 and a length direction axis of the purity correcting means 60 in a range of 30 degrees.

Different from this, if the fluorescent screen 130 is of a knot type in which three color fluorescent materials are arranged in lateral direction, or in a triangular form, if a direction of the purity correcting means 60 is turned at the front surface of the panel at which the distortion is occurred, the path of the electron beam is changed, to correct the distortion.

Accordingly, the purity correcting means 60 is fitted to a part correction of a front surface of the panel is required regardless of a range of angle, wherein the purity correcting means 60 is fitted to the front surface of the panel 1 such that a positive pole is parallel to y-axis of the panel 10, and y-axis of the correcting means and the tube axis (z-axis) of the electron beams 410 directed to a periphery of the screen are formed to cross perpendicular to each other or to be a range of angle of approx. 30 degrees.

Meanwhile, the fitting position of the purity correcting means that can shift the electron beams passed through, or at the shadow mask will be explained in more detail.

Embodiment 1

Referring to FIG. 6, as a first embodiment of the present invention, the purity correcting means 60 is fitted to a front surface of the panel for correcting a purity of the color cathode ray tube, within a range starting from an edge S of an effective screen to an effective end M of the shadow mask ‘M’, taking a screen area of the panel 10 and an empty space between a cabinet (not shown) covering an outer periphery of the panel 10 and the panel into account.

In this instance, it is required that the purity correcting means 60 is thin for fitting within the space between an outer surface of the panel and the cabinet without causing any interference with the cabinet.

The requirement is the same, that the purity correcting means is fitted to the outside surface of the panel 10 such that the y-axis of the purity correcting means 60 and the tube axis direction (z-axis) of the electron beams directed to the periphery of the screen are perpendicular to each other or form a range of angle within 30 degrees, and a direction of a polarity of the purity correcting means is fixed according to a structure of the screen.

Embodiment 2

Referring to FIG. 7, the purity correcting means 60 in accordance with a second preferred embodiment of the present invention may be fitted to an inside surface of the cabinet 70 which forms an outside case of the color CRT.

In a case the purity correcting means 60 is fitted in an escape recess of the cabinet for avoiding interference with sash of the cabinet 70, the purity correcting means 60 is fitted within a space between the edge ‘S’ in the escape recess and the effective end ‘M’ of the shadow mask.

In this instance, a position of the escape recess of the cabinet 70 is fixed such that the y-axis of the purity correcting means 60 and the tube axis direction (z-axis) of the electron beams directed to the periphery of the screen are perpendicular to each other or form a range of angle within 30 degrees.

Accordingly, the purity correcting means is spaced away from the front surface of the panel 10 within a range from the edge ‘S’ of the effective screen of the panel 10 to the effective end of the shadow mask.

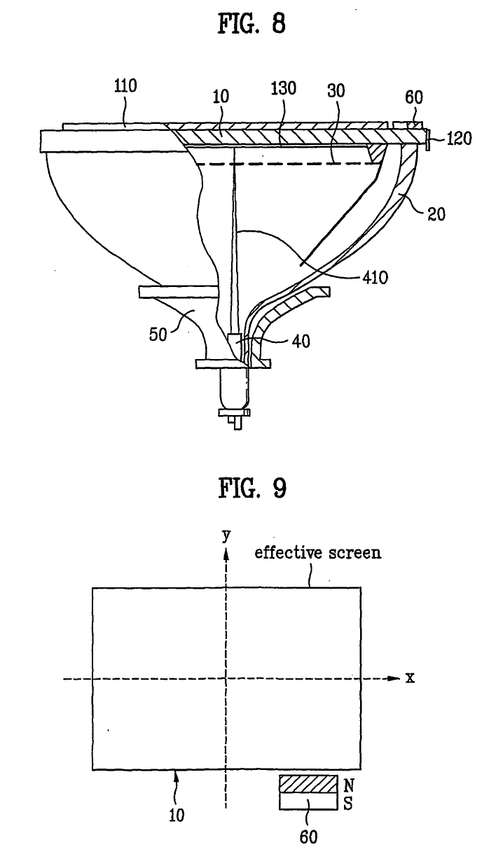

Meanwhile, referring to FIG. 8, in a case the purity correcting means 60 of the present invention is fitted to a flat color CRT, the purity correcting means 60 is fitted to a periphery of the front surface of the panel 10 between an anti-implosion glass 130 and an anti-implosion band 120 of the flat color CRT having the panel 10 of the fluorescent screen 130, the anti-implosion glass 110 fitted to the front surface of the panel 10, and the anti-implosion strap 120.

In this instance, for avoiding interference with the cabinet fitted to an outside of the color CRT, the purity correcting means is also fitted to the front surface of the panel within a space between the anti-implosion glass 130 and the anti-implosion strap 120, and has a thickness limitation, and may be fitted in a space in an escape recess formed in the cabinet.

The requirement is the same, that the purity correcting means is fitted to the outside surface of the panel 10 such that the y-axis of the purity correcting means 60 and the tube axis direction (z-axis) of the electron beams 41 directed to the periphery of the screen are perpendicular to each other or form a range of angle within 30 degrees.

According to this, when the color CRT is put into operation, the electron beams 410 scattered as the electron beams 410 pass the shadow mask 30 is involved in path shift in a purity correction amount almost the same with a picture distortion amount before landing, the distortion of a picture is minimized.

Since the three color electron beams emitted from the in-line type electron gun 40 (see FIG. 8) gather at a location in the vicinity of the shadow mask 30, such that the three color electron beams are at almost same distances from the purity correcting means 60, amounts of convergence of the electron beams are almost same, and almost no shift amount differences of the electron beams are occurred.

The method of fitting the purity correcting means 60 to the periphery of the shadow mask for correcting purity shift amount at the periphery of the screen is easy because a part with a poor purity around the periphery of screen can be corrected, directly.

That is, referring to FIG. 9, if the purity correcting means is fitted to a location intended to correct, an accurate correction of the part intended to correct together with a periphery thereof can be made as shown in FIG. 10 illustrating a corrected electron beam shift in a case the purity correcting means is fitted.

If it is assumed that the distortion of picture is occurred in a periphery of a lower right side of the screen of four equally divided panel 4, the purity correcting means 60 which can correct the distortion is fitted to the front surface of the panel 10, with the N pole positioned in an upper part thereof.

A fixed amount of correction is along a radius of rotation with reference to the part the purity correcting means 60 is fitted, thereby improving distortion of the picture.

In this instance, variation of the amount of correction by the purity correcting means 60 is made possible by varying a polarization amount and a fitting distance of a magnetic force generating means, and a plurality of the purity correcting means 60 may be fitted to the periphery of the panel at which the correction is required.

FIG. 11 illustrates a section showing a preferable fitting position of the purity correcting means 60 in accordance with a preferred embodiment of the present invention, schematically.

Referring to FIG. 11, L1 represents a purity (=landing) correction amount made by the purity correcting means 60, and L2 represents a distortion amount of a picture made by the purity correcting means. ‘M’ represents an effective end of the shadow mask, i.e., the farthest end the electron beams that can be shown on the screen can pass through, ‘Q’ represents a distance from the effective end ‘M’ of the shadow mask to the end of the effective screen of the panel, and ‘P’ represents a distance from the end of the effective screen to the purity correcting means.

An optimum fitting position of the purity correcting means 60 for attaining an accurate purity correction can preferably be expressed by an inequality 1.0<P/Q<2.0.

It is preferable that relations of the purity correction amount L1 by the purity correcting means and the picture distortion amount L2 by the purity correcting means are made within a range that satisfying an inequality 10.0<L2/L1<2.0.

It is preferable that the purity correcting means 60 of the present invention explained above is a magnetic material having a small polarization amount, such as 20-80 Gauss in a CRT for a color monitor of a computer, which has a relatively low Q value and requires a high resolution, and a magnetic material having a large polarization amount, such as 30-150 Gauss in a CRT for a domestic color TV.

A plurality of the purity correcting means may be fitted depending on area intended to correct for adjusting the correction amount, and a length of the purity correcting means may be adjusted with easy for correcting the purity.

### INDUSTRIAL APPLICABILITY

As has been explained, since the distortion amount of the electron beams are corrected in front of the shadow mask, the present invention is easy for adjusting the correction amount which improves the distortion amount, permits to improve a color purity, and improves misconvergence owing to the almost equal distances of the three color electron beams to the purity correcting means, thereby improving the color purity.

The perfect correction of the purity by using only the purity correcting means, such that no more re-correction of the picture distortion and misconvergence are required, prevents performance deterioration and defects of the deflection yoke caused by performance re-correction or additional correction of the deflection yoke, and since what is required is fitting two polar magnetic material to a periphery of the panel the distortion is occurred, the fabrication process is simple.

The foregoing simple fabrication process and the improvement of quality improves a productivity and a production cost of the color CRT.

What is claimed is:

1. A color cathode ray tube (CRT) having a panel forming a screen, a funnel of a bulb form fitted to rear of the panel, and a shadow mask fitted to the panel spaced away therefrom, comprising:
purity correcting means is fitted to a part in front of, or in side of the shadow mask near thereto.

2. A color CRT as claimed in claim 1, wherein the purity correcting means is fitted to an outside circumferential surface of the panel located in front of the shadow mask.

3. A color CRT as claimed in claim 1, wherein the purity correcting means is fitted such that a length direction axis or a direction of magnetic field forms a range of angle approx. within ±30 degrees to a tube axis of the electron beams emitted toward a panel.

4. A color CRT as claimed in claim 1, wherein the purity correcting means is fitted to a front surface of the panel within a range starting from an edge ‘S’ of an effective screen of the panel to an effective end ‘M’ of the shadow mask.

5. A color CRT as claimed in claim 2, wherein the purity correcting means is fitted to a front surface of the panel within a range starting from an edge ‘S’ of an effective screen of the panel to an effective end ‘M’ of the shadow mask.

6. A color CRT as claimed in claim 3, wherein the purity correcting means is fitted to a front surface of the panel within a range starting from an edge ‘S’ of an effective screen of the panel to an effective end ‘M’ of the shadow mask.

7. A color CRT as claimed in claim 1, wherein the purity correcting means is fitted to an inside of a cabinet covering the color CRT within a range starting from an edge ‘S’ of an effective screen of the panel to an effective end ‘M’ of the shadow mask.

8. A color CRT as claimed in claim 2, wherein the purity correcting means is fitted to an inside of a cabinet covering the color CRT within a range starting from an edge ‘S’ of an effective screen of the panel to an effective end ‘M’ of the shadow mask.

9. A color CRT as claimed in claim 3, wherein the purity correcting means is fitted to an inside of a cabinet covering the color CRT within a range starting from an edge ‘S’ of an effective screen of the panel to an effective end ‘M’ of the shadow mask.

10. A color CRT as claimed in claim 1, wherein the purity correcting means is fitted to a front surface of the panel within a space between an anti-implosion glass fitted to the front surface of the panel and an anti-implosion strap around the panel in a case the purity correcting means is fitted to a flat color CRT.

11. A color CRT as claimed in claim 2, wherein the purity correcting means is fitted to a front surface of the panel within a space between an anti-implosion glass fitted to the front surface of the panel and an anti-implosion strap around the panel in a case the purity correcting means is fitted to a flat color CRT.

12. A color CRT as claimed in claim 3, wherein the purity correcting means is fitted to a front surface of the panel within a space between an anti-implosion glass fitted to the front surface of the panel and an anti-implosion strap around the panel in a case the purity correcting means is fitted to a flat color CRT.

13. A color CRT as claimed in claim 1, wherein the purity correcting means is fitted to the front surface of the panel, with an N pole thereof directed upward or downward in parallel to a vertical axis of the panel when the screen is of a stripe type.

14. A color CRT as claimed in claim 1, wherein the purity correcting means is fitted to the front surface of the panel, or to an inside of a cabinet corresponding thereto.

15. A color CRT as claimed in claim 1, wherein a plurality of the purity correcting means are fitted for correcting purities at distortion positions of the picture, respectively.

16. A color CRT as claimed in claim 1, wherein the purity correcting means is fitted within a range that satisfying an inequality 10.0<L2/L1<2.0, where L1 represents a purity (=landing) correction amount by the purity correcting means and L2 represents a picture distortion amount by the purity correcting means.

17. A color CRT as claimed in claim 1, wherein the purity correcting means is fitted within a range that satisfying an inequality 1.0<P/Q<2.0, where ‘M’ represents an effective shadow mask area with reference to a tube axis direction, ‘Q’ represents a distance from the effective end of the shadow mask to the end of the effective screen of the panel, and ‘P’ represents a distance from the end of the effective screen to the purity correcting means.

18. A color CRT as claimed in claim 1, wherein the purity correcting means is a magnetic material having approx. 20-80 Gauss in a high resolution color CRT, and 30-150 Gauss in a low resolution color CRT.
